(19) United States
(12) Patent Application Publication
(10) Pub. No.: US 2007/0042176 A1
(43) Pub. Date: Feb. 22, 2007

(54) Rewritable and erasable writing sheet

(76) Inventor: Takashi Sugibuchi, Sagamihara (JP)

Correspondence Address: 3M INNOVATIVE PROPERTIES COMPANY, PO BOX 33427, ST. PAUL, MN, 55133-3427, US

(21) Appl. No.: 10/563,700

(22) PCT Filed: Jun. 17, 2004
(86) PCT No.: PCT/US04/19654

§ 371 Date: May 22, 2006

(30) Foreign Application Priority Data
Jul. 7, 2003 (JP) 2003-193026

(51) Int. Cl. B32B 5/16

(52) U.S. Cl. 428/331; 428/336

(57) ABSTRACT

The invention is rewritable and erasable writing sheet. The writing sheet comprises a base film, and a rewritable and erasable information recording layer formed on the base film. The information recording layer comprises a mat material composed of silicone particles, and a release material.

### BACKGROUND

The present invention relates to a writing sheet. More specifically, it relates to a writing sheet which allows repeated writing and erasing of information such as characters and line drawings using an ordinary writing tool such as a pencil.

Rewritable and erasable information recording panels are well known in the prior art and include blackboards, whiteboards and the like, and recently magnetic panels having magnetic powder encapsulated in viscous fluid have also been introduced. However, special writing tools are required for all such information recording. Specifically, information recording on a blackboard requires chalk, information recording on a whiteboard requires an alcohol pen, and information recording on a magnetic panel requires a special pen housing a permanent magnet.

On the other hand, there have also been disclosed rewritable and erasable writing sheets for use with ordinary writing tools such as pencils, which are commonly found in the office or home. Japanese Examined Utility Model Publication (kokoku) No. 4-13156 discloses a writing sheet comprising a specified amount of silicon-based inorganic particles (e.g. silica), on the rough surface of a polyolefin film having a specified surface roughness. Japanese Unexamined Patent Publication (kokai) No. 59-107000 discloses a writing sheet having one rough side which is a film comprising an inorganic material such as clay powder in a synthetic resin such as polypropylene or the like. These writing sheets of the prior art are made the inorganic powder material exposed on the surface in order to enhance the writing property. Such sheets have been problematic, however, in that when erasing is carried out with an eraser or the like after writing with, for example, a pencil, the colored powder of the pencil adheres to the protruding inorganic powder, thus hampering complete erasure.

### SUMMARY OF THE INVENTION

The invention is rewritable and erasable writing sheet. The writing sheet comprises a base film, and a rewritable and erasable information recording layer formed on the base film. The information recording layer comprises a mat material composed of silicone particles, and a release material.

### BRIEF DESCRIPTION OF THE DRAWINGS

FIG. 1 is a perspective view of an embodiment of the writing sheet of the invention.

FIG. 2 shows a cross-section of the writing sheet of FIG. 1.

### DETAILED DESCRIPTION OF THE INVENTION

One objective of the present invention to provide a writing sheet which allows easy and complete erasure of information recorded with an ordinary writing tool such as a pencil.

The present inventive writing sheet allows easy writing or drawing of information with an ordinary writing tool such as a pencil, as well as easy erasure of the written or drawn information, thereby making it possible to accomplish repeated rewriting and erasing.

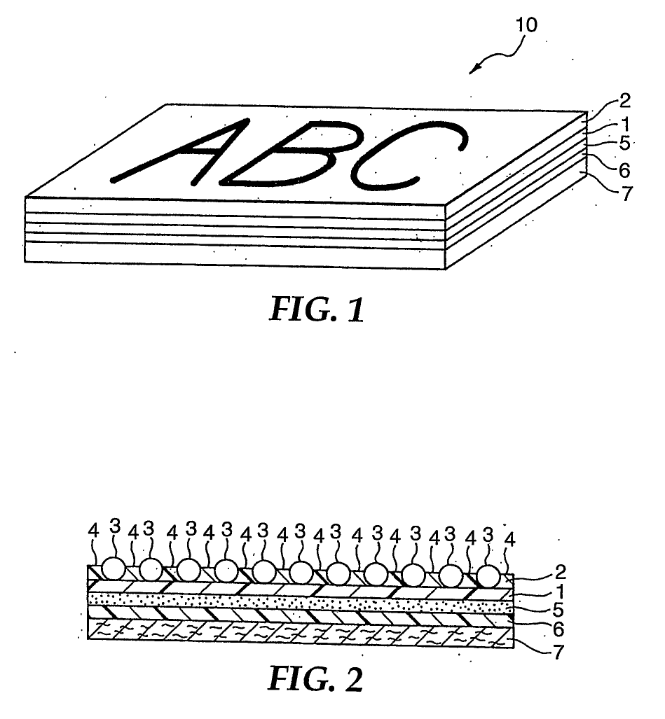

A preferred mode of the invention will now be explained. The writing sheet of the invention is a writing sheet having an information recording layer on a base film. FIG. 1 is a perspective view of an embodiment of the writing sheet of the invention. As seen in FIG. 1, the writing sheet 10 of the invention is provided with an information recording layer 2 formed on a base film 1. The base film 1 of the writing sheet 10 is bonded to a support 7 having a printed layer 6 thereon, via an adhesive layer 5. FIG. 2 shows a cross-section of the writing sheet of FIG. 1. As shown here, a mat material (composed of silicone particles) 3 is evenly dispersed in a release material 4 to form the information recording layer 2.

Base Film

The writing sheet of the invention comprises a base film as a base to support the information recording layer. The base film is not particularly restricted so long as it can maintain its writing property with sufficient color density on the information recording layer and maintain sufficient erasing property with repeated use. The base film used may be a material with suitable flexibility and hardness to ensure adequate writing and erasing properties. Such a material can provide appropriate hardness for the recording surface of the information recording layer on the base film, to prevent damage or impairment of the information recording layer from ordinary writing pressure (for example, 3-10 Pa, same hereunder). Such materials may generally be plastic films such as polyethylene terephthalate (PET), polypropylene (PP), acetate films and the like, with polyethylene terephthalate (PET) being a preferred material for the base film.

The thickness of the base film is not particularly restricted so long as it is selected so as to provide the appropriate hardness as described above, but it will usually be 30-70 μm. In the case of polyethylene terephthalate (PET), a base film thickness of greater than 70 μm may render the writing sheet too hard and prevent transfer of the coloring agent (e.g. pigment) of the writing tool to the information recording layer with normal writing pressure. On the other hand, a thickness of less than 30 μm may allow adequate transfer of the coloring agent of the writing tool into the information recording layer, but will tend to make the writing sheet too soft, causing the information recording layer to sink under normal writing pressure and leaving traces which can prevent erasure with erasing tools (for example, erasers). The thickness of the base film may be appropriately determined based on factors including the material of the base film, and the expected writing pressure and hardness of the writing tool (pencil, etc.).

The base film may be colorless transparent, colored transparent, semi-transparent or opaque. When the base film is transparent or semi-transparent, the printed layer may be formed on the back side of the base film for visibility of an image on the surface of the writing sheet.

Information Recording Layer

The information recording layer allows repeated writing and erasing by fixing a coloring agent of a writing tool such as a pigment or dye to its surface and by erasing it with an erasing tool. The information recording layer is formed by evenly dispersing a mat material composed of silicone particles in the release material.

Mat Material

The mat material composed of silicone particles captures the pigment or other coloring agent onto the surface of the information recording layer during writing, to allow recording to be accomplished. The mat material is composed of silicone particles and therefore has a low surface energy. Thus, the coloring agent such as a pigment or dye is only temporarily fixed and can be erased with an erasing tool. The mat material is preferably exposed partially on the surface of the information recording layer, because exposure of the mat material facilitates capture of the coloring agent and enhances the writing and drawing properties. The sizes of the silicone particles of the mat material are preferably from 1 to 3 μm. The silicone particles are not limited to spherical shapes, and may be elliptical or other shapes. In cases where the shapes are non-spherical, the particle size refers to the shortest diameter passing through the center of gravity of the particles, such as the short-axis diameter. A particle size of smaller than 1 μm will not ensure capturing of the coloring agent, while a particle size of larger than 3 μm may not produce fine images.

The silicone particles of the mat material are composed of a highly rigid silicone polymer. If the rigidity of the silicone polymer is too low, the pigment component cannot be rubbed off when the writing tool (pencil, etc.) contacts with the polymer particles, and an adequate writing property therefore cannot be ensured. Insufficient rigidity may also result in sinking or damage under writing pressure, making it impossible to perform erasure with an erasing tool. A silicone polymer yielding silicone particles with adequate rigidity is preferably obtained by curing a low molecular weight silicone resin having trifunctional or tetrafunctional units, and is more preferably a cured silicone resin having a cured molecular weight of from a few tens of thousands to 100,000. The molecular weight referred to here is the number average molecular weight obtained by gel permeation chromatography (GPC) measurement using a polystyrene-filled column. Such a silicone resin forms a three-dimensional network structure upon curing, to allow formation of highly rigid particles and providing satisfactory writing and erasing properties.

The amount of mat material is not particularly restricted, but will normally be 3-10 wt % based on the weight of the information recording layer including the mat material and release material. If the amount of mat material is too little, the coloring agent-capturing property, and therefore the writing property, may be inadequate. If it is too great, the erasing property may be inadequate and the release material may not be able to hold the mat material with sufficient force.

Release Material

The release material holds the silicone particles of the mat material while also constituting at least a part of the surface of the information recording layer. The release material preferably has a sufficient adhesive property to a coloring agent to temporarily fix a coloring agent captured by the mat material during writing, but also has sufficiently low surface energy to allow easy erasure of the coloring agent with an erasing tool. The release material also preferably has a higher surface energy than the silicone particles of the mat material in order to confer an adequate writing property, to thus facilitate adhesion of coloring agents such as pigments or dyes to the information recording layer.

An example of a suitable release material is a composition comprising an acrylic, urethane or alkyd polymer with long-chain aliphatic groups. The long-chain aliphatic groups are, for example, C₁₂-C₂₂ aliphatic groups, and are preferably linear aliphatic groups and especially linear alkyl groups. More specific examples include dodecyl, tetradecyl, hexadecyl, octadecyl (stearyl), eicosanyl and docosanyl groups. The release material is preferably a polymer with a plurality of long-chain aliphatic groups as side chains. For example, an acrylic polymer with long-chain aliphatic groups may be a polymer obtained by copolymerization of stearyl acrylate with a comonomer such as acrylonitrile. A urethane polymer with long-chain aliphatic groups may be a polymer obtained by reaction of stearyl isocyanate with a polymer having a plurality of isocyanate-reactive sites, such as polyvinyl alcohol.

The information recording layer preferably has a thickness of 1-2 μm, expressed as the thickness up to the surface of the release material. Such a thickness will result in partial exposure of 1-3 μm silicone particles on the surface of the information recording layer, thereby ensuring the ability to capture coloring agents.

Optional Layers

The writing sheet of the invention may also comprise separate layers in addition to the base film and information recording layer. For example, a support such as a mount may be additionally formed on the back side of the base film of the writing sheet. A support such as a mount may be attached to the base film using an adhesive or double-sided adhesive tape. Provision of a mount will allow flat anchoring of the writing sheet, making it possible to accomplish drawing regardless of location. Such a mount will usually be a base paper, and is preferably cardboard with a weight of 150-300 g/m².

When the base film is transparent or semi-transparent, a printed layer may be further provided on the back side of the base. The printed layer may be, for example, a decorative layer bearing comic characters or illustrations.

Fabrication of Writing Sheet

The writing sheet of the invention may be fabricated in the following manner.

First, the release material is dissolved in an appropriate solvent such as ethyl acetate, and the mat material composed of silicone particles is dispersed in the solution to form a precursor coating composition for the information recording layer. The coating composition is coated onto the base film with appropriate means such as a knife coater, and then dried to obtain a writing sheet according to the invention. If necessary, an adhesive may be coated or double-sided adhesive tape attached to the back side of the base film, for attachment to a support such as a mount. A printed layer may also be preformed on the support or the base film before attachment.

Use of Writing Sheet

The writing sheet of the invention may be used, for example, in the following manner.

When the writing sheet includes a printed layer bearing outlines of comic characters or illustrations, it may be useful as a child's toy for repeated coloring using an ordinary writing tool. That is, children may draw by hand on the writing sheet to easily complete color drawings with colored pencils or the like over predrawn characters. Also, upon completion of coloring, the information recording layer surface (including the mat material) may be cleaned with an ordinary erasing material such as an alcohol cleanser to allow complete erasure of the coloring agent.

Alternatively, the writing sheet of the invention may be suitably used as any writing sheet which is intended for repeated rewriting and erasing, such as a bulletin board.

### EXAMPLES

### Example 1

1. Fabrication of Writing Sheet

In a solution of an acrylic release material (Piroyl 1050, trade name of Ipposha Yushi) in an ethyl acetate solvent there was dispersed a mat material composed of silicone particles with a mean particle size of 2 μm (KMP590, trade name of Shinetsu Chemical Co., Ltd.) in an amount of 8 wt % (amount with respect to the solid weight of the release material), to obtain an information recording layer precursor coating composition. The surface of a 50 μm thick polyethylene terephthalate (PET) film (base film) which had been corona treated on both sides was then coated with the coating composition using a knife coater, and dried to form an information recording layer on the base film to a coating coverage of 1.5 g/m². The thickness of the formed information recording layer was 1.2 μm. Cardboard with a basis weight of 250 g/m² was attached to the back side of the PET film using double-sided adhesive tape.

2. Evaluation of Writing Sheet

Information was recorded onto the aforementioned writing sheet using black, blue, red, pink and green colored pencils (12 Colored Pencil Box, trade name of Tombo Pencil Co.), at a writing pressure of 8 Pa. Tissue paper which contained an erasing agent composed of a mixture of isopropyl alcohol and n-propyl alcohol (1:1 weight ratio) was used to lightly wipe the information on the writing sheet at a pressure of about 7 Pa. The information was completely erased in this way. The information recording and erasing procedures were repeated 30 times, and upon visual observation of the writing sheet,. no staining or deterioration of the writing sheet was found.

### Example 2

A writing sheet was formed in exactly the same manner as Example 1. A marker pen (Aqueous Ink Pen, trade name of black aqueous pen by Pentel) was used to record information on the writing sheet at a writing pressure of 5 Pa. After drying for 10 minutes, tissue paper which contained an erasing agent composed of a mixture of isopropyl alcohol and n-propyl alcohol (1:1 weight ratio) was used to lightly wipe the information on the writing sheet at a pressure of about 7 Pa. The information was completely erased in this way. The information recording and erasing procedures were repeated 30 times, and upon visual observation of the writing sheet, no staining or deterioration of the writing sheet was found.

### Example 3

A writing sheet was formed in exactly the same manner as Example 1. A oil-based ink pen (Magic Ink, trade name of black oil-based pen by Teranishi Chemical Industry Co., Ltd.) was used to record information on the writing sheet at a writing pressure of 5 Pa.

After drying for 10 minutes, tissue paper which contained an erasing agent composed of a mixture of isopropyl alcohol and n-propyl alcohol (1:1 weight ratio) was used to lightly wipe the information on the writing sheet at a pressure of about 7 Pa. The information was completely erased in this way. The information recording and erasing procedures were repeated 30 times, and upon visual observation of the writing sheet, no staining or deterioration of the writing sheet was found.

### Comparative Examples 1-3

Tests were conducted in exactly the same manner as Examples 1 to 3, except that silicon oxide inorganic powder (FINESIL E-50, trade name of silicon oxide particles by Tokuyama Co., Ltd.) was used instead of the silicone particles. The writing sheets were found to have staining or deterioration with the pigment or dye, and did not allow repeated rewriting and erasing.

The writing sheet of the invention allows easy writing or drawing of information with an ordinary writing tool such as a pencil, as well as easy erasing of the written or drawn information, thereby making it possible to accomplish repeated rewriting and erasing.

1-5. (canceled)

6. A rewritable and erasable writing sheet comprising
a base film, and
a rewritable and erasable information recording layer formed on the base film, the information recording layer comprised of a mat material composed of cured silicone particles having a particle size from about 1 to 3 μm, and a release material, wherein the silicone particles are at least partially exposed at the surface of the information recording layer.

7. A rewritable and erasable writing sheet according to claim 6, wherein said mat material is present in an amount of about 3 to 10 wt % based on the weight of the information recording layer.

8. A rewritable and erasable writing sheet of claim 6, wherein said release material comprises a polymer having long-chain aliphatic groups.

9. A rewritable and erasable writing sheet of claim 6, wherein the information recording layer has a thickness of from 1 to 2 μm.
